(19) United States
(12) Patent Application Publication
(10) Pub. No.: US 2026/0280216 A1
(43) Pub. Date: Sep. 17, 2026

(54) METHODS AND APPARATUSES FOR RF AMPLIFIER POWER TRANSIENT MITIGATION WITH IDLE TONES

(71) Applicant: IonQ, Inc., College Park, MD (US)

(72) Inventors: Joachim WELTE, Carrboro, NC (US); Kevin Landsman, Rockville, MD (US); Steven Friedman, Silver Spring, MD (US)

(21) Appl. No.: 18/988,094

(22) Filed: Dec. 19, 2024

Related U.S. Application Data
(60) Provisional application No. 63/612,855, filed on Dec. 20, 2023.

(51) Int. Cl. H01S 3/00; G02F 1/11; G06N 10/40

(52) U.S. Cl. CPC H01S 3/0085; G02F 1/113; G06N 10/40

(57) ABSTRACT

Aspects of the present disclosure may include methods and systems for applying a first RF tone, at a first RF power and a first RF frequency, to modulate at least one laser beam into a first modulated laser beam via an acousto-optic device, providing the first modulated laser beam to at least one target ion of an ion chain in the QIP system, applying a second RF tone, at a second RF power and at a second RF frequency different than the first RF frequency, to modulate the at least one laser beam into a second modulated laser beam via the acousto-optic device, and providing the second modulated laser beam to one or more ions in the ion chain, wherein the second modulated laser beam does not change any quantum state of the one or more ions.

### CROSS-REFERENCE TO RELATED APPLICATIONS

The current application claims priority to, and the benefit of United States Provisional Application No. 63/612,855 filed Dec. 20, 2023 and entitled “METHODS AND APPARATUSES FOR RF AMPLIFIER POWER TRANSIENT MITIGATION WITH IDLE TONES,” the contents of which are hereby incorporated by reference in their entireties.

### BACKGROUND

In a quantum information processing (QIP) system, laser beams may be used to control and/or read the states of trapped ions. The lasers beams may be modulated to control their deflection angles, frequencies, phases, and/or amplitudes. One example of such modulation scheme includes using an acousto-optic device, such as an acousto-optic modulator (AOM) or an acousto-optic deflector (AOD). In an AOM or an AOD, a radio frequency (RF) driver drives a transducer to generate an acoustic wave in a crystal. As a source laser beam passes through the crystal (during the generation of the acoustic wave), the oscillation of the crystal causes the source laser beam to be modulated and exits the crystal as a modulated laser beam. However, the states of the trapped ions are very sensitive to various properties of the modulated laser beams. Therefore, it is important for the RF driver to output a stable driving signal to ensure high fidelity during the modulation of the trapped ions. As a result, improvements in driving an RF signal may be important.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure may include methods and systems for applying a first radio frequency (RF) tone, at a first RF power and a first RF frequency, to modulate at least one laser beam into a first modulated laser beam via an acousto-optic device, providing the first modulated laser beam to at least one target ion of an ion chain in the QIP system, applying a second RF tone, at a second RF power different than the first RF power and at a second RF frequency different than the first RF frequency, to modulate the at least one laser beam into a second modulated laser beam via the acousto-optic device, and providing the second modulated laser beam to one or more ions in the ion chain, wherein the second modulated laser beam does not change any quantum state of the one or more ions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain according to aspects of the present disclosure.

FIG. 2 illustrates an example of a quantum information processing (QIP) system according to aspects of the present disclosure.

FIG. 3 illustrates an example of a computer device according to aspects of the present disclosure.

FIG. 4 illustrates an example of a system including an acousto-optic modulator (AOM) according to aspects of the present disclosure.

FIG. 5 illustrates an example of a system including an acousto-optic deflector (AOD) according to aspects of the present disclosure.

FIG. 6 illustrates examples of schemes power transient mitigation according to aspects of the present disclosure.

FIG. 7 illustrates an example of a method for reducing transients in a RF driver according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Performing high fidelity gate operations in trapped ion quantum computers may require high fidelity modulation of laser beams with acousto-optical devices. Modulation may be performed in intensity, frequency or phase-space, or any combination thereof. The fidelity of the modulation refers to how well the time-dependent traces of the modulated laser beam parameters (intensity, phase, frequency) match the intended parameters.

One high fidelity modulation method may include a scheme to maintain same RF power dissipation into the acousto-optic device to improve fidelity. The magnitude of this effect may depend on the type of acousto-optical material used, the amount of power dissipated into the device, the wavelength of the light used and other factors.

While those effects may be substantial on the timescale of seconds, they are not very relevant on the typical timescales of gate operations in trapped ion quantum computers. And even less so on the timescales of neutral atom quantum gate operations. The RF amplifiers may be a main contributor to fidelity-reducing transient phenomena on those much shorter timescales. Depending on the type of amplifier, several concurrent and sometimes competing transient phenomena can happen. For example, for a sequence of ideally rectangular pulses of the same height (i.e., same RF power), it might be that the first pulse is lower than the rest of the sequence. In other cases, there could be a linear gradient in RF power output over the sequence. Alternatively, each pulse could be deformed from an ideal rectangle to a pulse with smoothed out edges. In another example, all of the above and additional phenomena may occur to cause an increase in the transient behaviors.

The deviation from the ideal pulse shape typically scales linearly with RF power and may be on the order of several percent (i.e., RF power deviation relative to RF power target). This means that one way of compensation would be to operate at low RF power. Unfortunately, this also means that the resulting efficiency of the acousto-optic devices will be reduced, which may lead to higher optical power input required, which then results in an accelerated damage mechanism. Hence, operating the acousto-optic devices at their intended RF input power levels may be preferable.

In certain aspects, the schemes for reducing RF power transients may be implemented in a QIP system. For example, the schemes may be used to reduce RF power transients that drive the acousto-optic modulators and/or the acousto-optic deflectors used for controlling the states of trapped ions in the QIP system. In other aspects, the schemes for reducing RF power transients may be implemented in other applications.

Aspects of the present disclosure may include reducing RF power transients. The schemes utilized in the current disclosure may advantageously reduce RF power transients without requiring using complex RF driving circuitries and/or operating in a lower range of a high power RF driver (both of which may increase costs to the QIP system).

An aspect of the present disclosure is to ensure that the RF amplifiers are operating at a constant RF output power. To accommodate the switching schemes required for high-fidelity gate operations, an idling scheme is used. During idling, the amplifiers operate at a frequency that is off-resonant from the gate operation. Specifically, the amplifiers may maintain an output signal that does not change the gate operation. This may require - depending on the type of gate - shifting the RF drive by several megahertz (MHz) to several tens of MHz from the target frequency for gate operation. Depending on the impedance matching of the acousto-optic device, this scheme may require shifting the RF frequencies by several hundreds of MHz. Alternatively or additionally, the scheme may require using isolators or circulators to protect either the acousto-optic device or the amplifiers.

During gate operation, the amplifiers may operate either with all power going into the target frequency tone, or with part of the power going to the target tone and the rest going to the idle tone. In one scheme, the idle RF power may equal to the RF power during the gate operation, except that the amplifier output is only shifted in frequency. This scheme may allow for the stabilization of RF power at one level. As such, the frequency modulated (FM) gates could be advantageous in terms of reduced context dependency, shifting only the frequency and operating at constant RF power.

In some instances, there may be phase transient errors from switching between frequencies, or transient sidebands generated in the AOMs by incoming “new” tones overlapping with reflected “old” tones (AOM standing wave effects).

One aspect of the present disclosure includes linearizing the target power because of the way the RF amplifier compresses signals at high power. This may require a corresponding increase in the idle power. The selection of the idle frequencies may be done carefully to ensure no unwanted atomic transitions and/or light shifts are introduced onto the qubits (which includes inter-modulation spurs created by non-linearities in the signal chain).

In another aspect, the idling power may be set to the maximum of a number of RF power levels that are used in different gate schemes. During gate operation, the amplifier then outputs two tones, one at the target frequency and power, and one at the idle frequency with a power level that adds to the target power to maintain a constant output power. And as the target power changes depending on gate type or during the gate, the idle power changes accordingly.

In a generalized scheme, the scheme described above may be extended to N target tones, which may be output from the amplifier in series or in parallel. And an (N+1)th tone that is purely for idling and has its power adjusted for constant RF power output. For example, 5 tones may be output from the amplifier, with 4 tones being used for modulating/deflecting lasers and 1 tone being used as the idle tone. As the 4 tones vary in output power, the idle tone may be adjusted to maintain a constant RF power output.

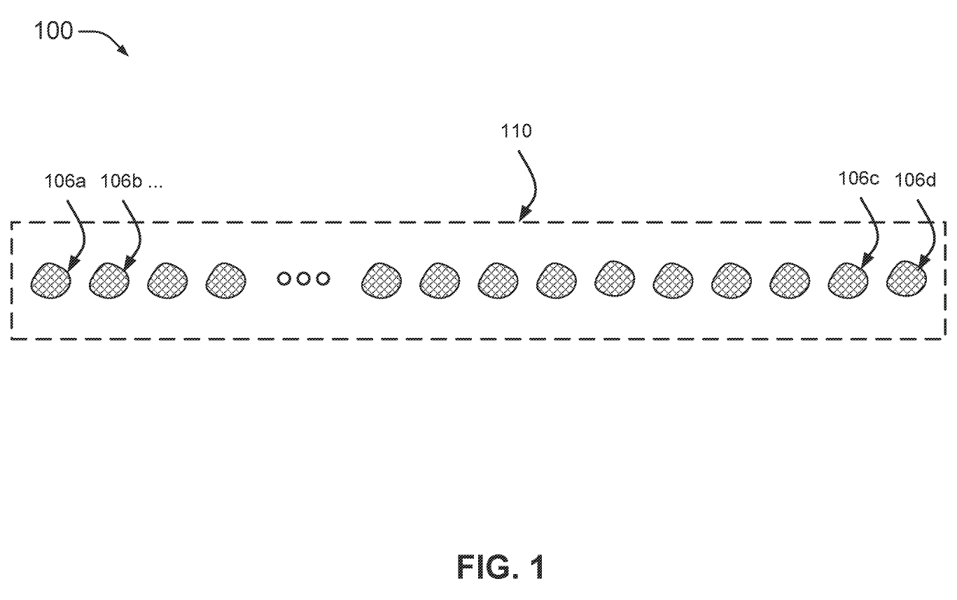

Example QIP systems that may implement aspects of the present disclosure are shown in FIGS. 1-3.

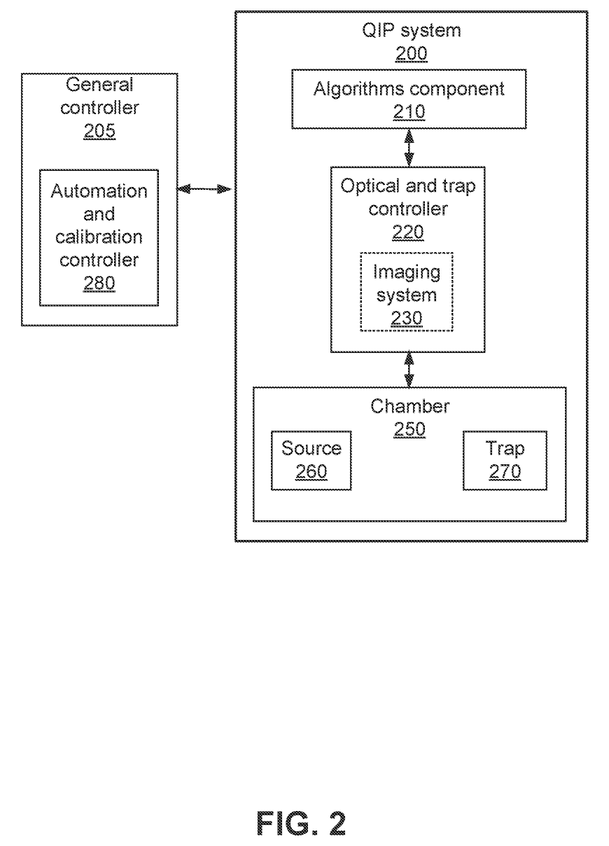

FIG. 1 shown below illustrates a diagram 100 with multiple atomic ions 106 (e.g., atomic ions 106a, 106b, …, 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used (such as one or more isotopes of barium, for example). The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure.

The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. The optical and trap controller can include one or more optical sources for generating lasers to address and read ions in ion trap 270. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, the optical and trap controller 220, and/or the imaging system 230.

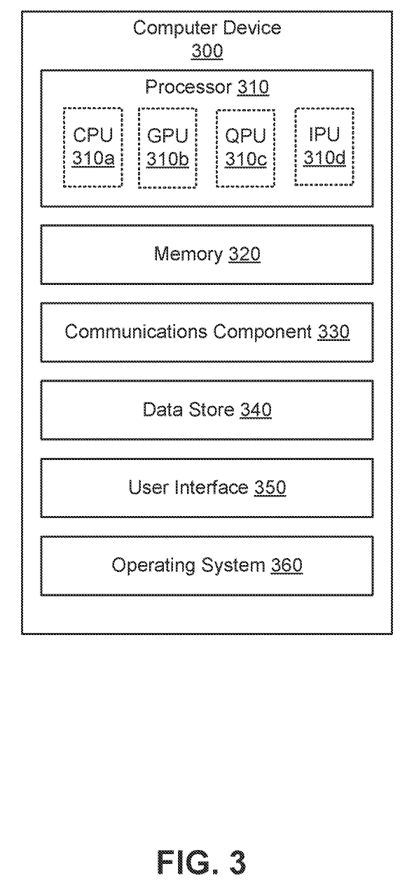

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

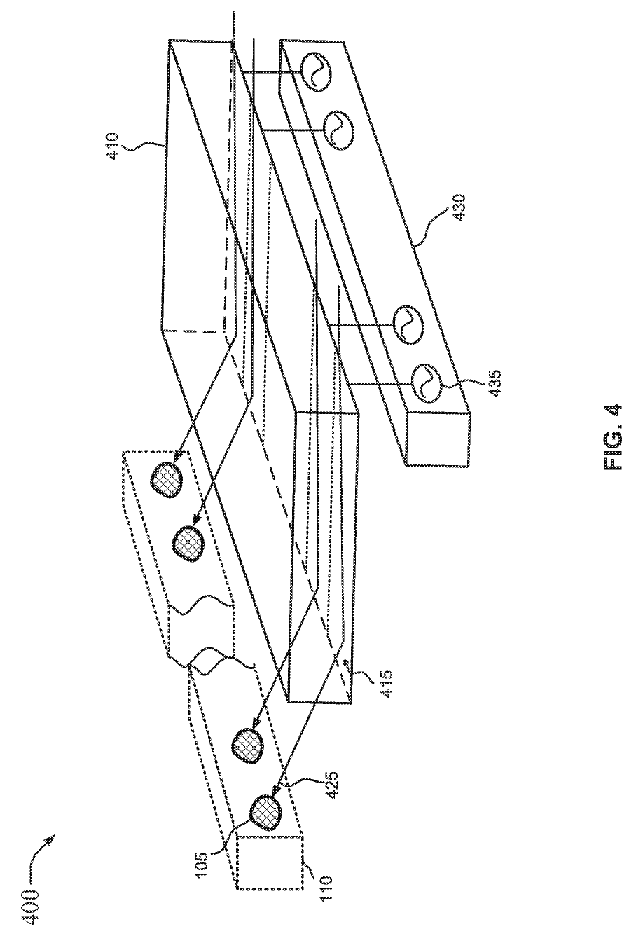

FIG. 4 shows an exemplary system 400 including an AOM 410 configured to control a modulation scheme for addressing individual ions in the ion chain. The system 400 includes the chain 110 with the ions 105 shown in the diagram 100 in FIG. 1, which may be illuminated by the individual addressing optical beams 425 from one direction. It should be appreciated that the ion chain 110 are configured as an ion trap, such as ion trap 270 of FIG. 2. Moreover, in an exemplary aspect, the individual addressing optical beams 425 can be controlled and generated by optical and trap controller 220, as described above. In some instances, a global optical beam (not shown) may be used to illuminate the ions 105 from a different or opposite direction to that of the optical beams 425. The AOM 410 may be a multi-channel Bragg cell having multiple piezo-electric transducers 415 (e.g., in a parallel arrangement) that locally apply acoustic waves to the AOM 410, where each channel has its own piezo-electric transducer 415. The AOM 410 may include a different channel for each of the ions 105. In some instances, the AOM 410 may include one or more additional channels to the ones needed for the ions 105. The piezo-electric transducers 415 may be controlled by a RF controller 430 having waveform generators 435 and/or optional amplifiers. The waveform generators 435 may be arbitrary waveform generators (AWGs) and/or direct digital synthesizers, or some other type of signal generating device.

In some instances, the RF controller 430 may be configured to apply one or more RF tones according to aspects of the present disclosure.

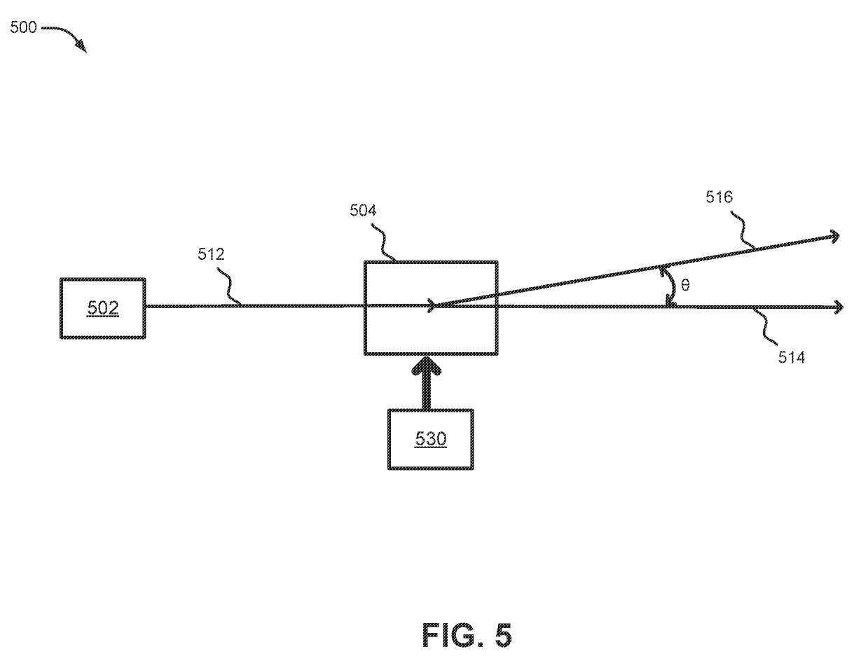

FIG. 5 illustrates an exemplary AOD system 500. The AOD system 500 includes a light source 502 (e.g., an optical source of optical and trap controller 220) that is configured to produce a source beam 512 (e.g., a laser). The AOD system 500 may include an AOD 504 configured to diffract at least a portion of the source beam 512 to output a remaining source beam 514 and at least one diffracted beam 516. The remaining source beam 514 and the at least one diffracted beam 516 may be emitted from the AOD 504 with an angle difference of an angle θ. The angle θ shown here may be 0.01º, 0.1º, 1º, 10º, or other degrees. The range of the angle θ may span a range of 0.001º to 90º. In some aspects, the AOD 504 may include a transducer (not shown) configured to apply one or more acoustic waves to diffract the source beam 512.

In some aspects, the AOD system 500 may include a RF controller 530 configured to apply one or more RF tones to the transducers to generate the acoustic waves.

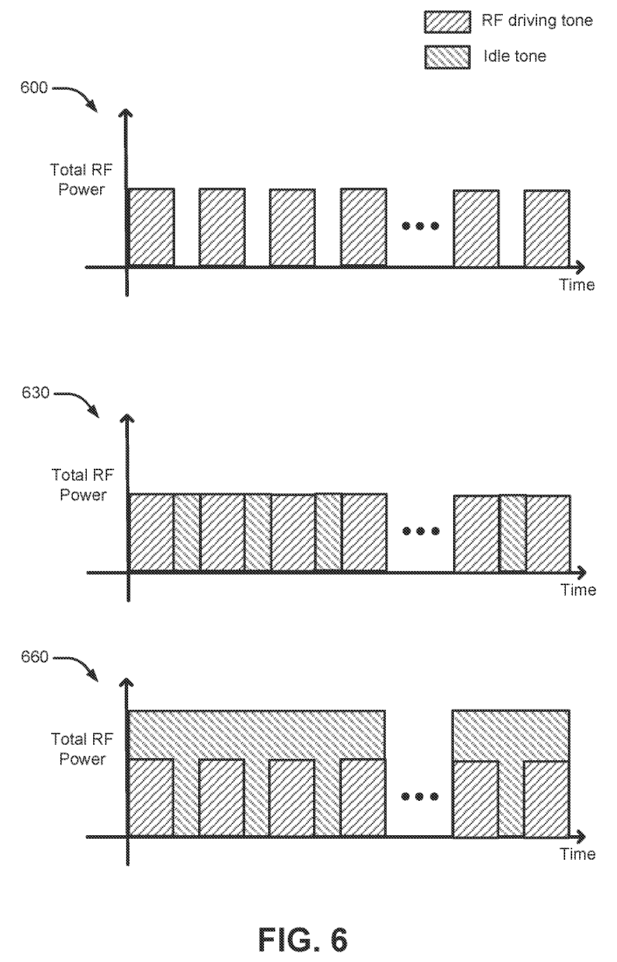

FIG. 6 illustrates applied RF tones with and without idle tones according to aspects of the present disclosure. The RF tones may be applied to the AOM 410 and/or the AOD 504 as laser beams pass through the AOM 410 and/or the AOD 504. The applied RF tones may change the frequency, the phase, and/or the amplitude of the laser beams in the AOM 410 and/or the frequency, the amplitude, and/or the deflection angle of the laser beams in the AOD 504.

In certain aspects, a first graph 600 shows an example of the application of RF tones without idle tones. Here, a RF driver (such as the RF controller 430 or 530) may apply a RF tone intermittently. The RF controller 430, 530 may include optional amplifiers that boost the amplitudes of the output signals. When the RF driving tone is applied, the total RF power may fluctuate between 0 and any RF power level the RF driver is configured to apply. However, since the RF driver has to toggle between partial/full RF power and 0 RF power to apply the RF tone and shutting down the RF tone, transients (e.g., power undershoot, power overshoot, or other types of non-idealities/artifacts, etc.) may occur (not shown), which may distort the square waveform of the RF tone shown in the first graph 600. If used for the modulation of a laser beam via an acousto-optic device associated with an ion chain, such distortion may degrade the fidelity of the trapped ion states in the ion chain.

In some aspects of the present disclosure, a second graph 630 shows an example of the application of RF tones with idle tones according to aspects of the present disclosure. Here, the RF driver (such as the RF controller 430 or 530) may apply a RF tone intermittently. In between the RF tone applications, the RF driver may apply an idle tone. Therefore, the RF driver may maintain a constant power output, and toggle between the RF tone (e.g., used for modulating a laser beam to perform a gate operation associated with trapped ions in the ion chain) and the idle tone (e.g., used modulating a laser beam that does not impact any gate operation). In one aspect of the present disclosure, the RF driver may maintain a constant power output, and change the frequency to toggle between the RF tone and the idle tone. In other aspects, other parameters (e.g., phase) may be changed between the RF tone and the idle tone.

In certain aspects of the present disclosure, a third graph 660 shows another example of the application of RF tones with idle tones according to aspects of the present disclosure. Here, the RF driver (such as the RF controller 430 or 530) may apply a RF tone intermittently. The RF driver may also an idle tone that overlap with the RF tone applications and in between the RF tone applications. In between the RF tone applications, the RF driver increase the idle tone power to compensate for the lack of RF tone applications. Therefore, the RF driver may maintain a constant power output, and toggle between the RF tone and idle tone (e.g., used for modulating a laser beam to perform a gate operation associated with trapped ions in the ion chain), and the idle tone only (e.g., used modulating a laser beam that does not impact any gate operation). In one aspect of the present disclosure, the RF driver may maintain a constant power output, and change the frequency to toggle between the RF tone and the idle tone. In other aspects, other parameters (e.g., phase) may be changed between the RF tone and the idle tone.

In one aspect of the present disclosure, the RF driver in the third graph 660 may maintain the constant power output at a maximum power output. During the application of the RF tone, if the power supplied to the RF tone is increased, the RF driver may correspondingly decrease the power supplied to the idle tone to maintain the constant power output.

In the examples shown in the second graph 630 and the third graph 660, the application of a single RF tone is shown. However, aspects of the present disclosure include the application of multiple RF tones while using one or more idle tones to maintain the constant power output.

In another instances, two or more RF tones may be controlled separately to maintain a constant power output. For example, at a first time, the first RF tone may be “high” while the second RF tone may be “low.” At a second time, the first and second RF tones may both be tuned to “middle” to maintain a constant power output to reduce transient.

In certain aspects, the idle tone may be at a frequency such that, when applied to a transducer of an acousto-optic device, causes a modulated light beam that does not alter the quantum operation of the ion chain. Specifically, the modulated light beam from the idle tone may change the states of some or any qubit in the ion chain.

Examples of an acousto-optic device may include an acousto-optic material or an acousto-optic crystal. The acousto-optic device may be made from fused silica, lithium niobate, telluride dioxide, crystalline quartz, chalcogenide glasses, indium phosphide, germanium, and/or other suitable materials that exhibit acousto-optic behaviors.

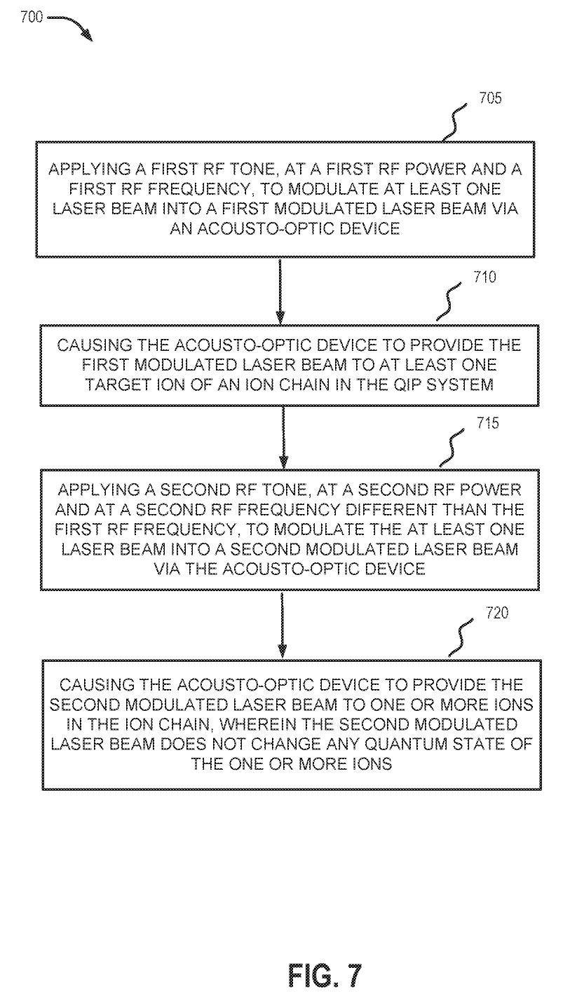

FIG. 7 illustrates an example of a method 700 of stabilizing the motional mode spectrum via side-channel measurement of ion positions according to aspects of the present disclosure. In general, it is noted that the method 700 may be performed by the general controller 205, the algorithm component 210, the optical and trap controller 220, the imaging system 230, the processor 310, the memory 320, and/or one or more subcomponents of the QIP system 200 or the computer device 300 according to various exemplary aspects as described above.

Initially, at 705, the method 700 may apply a first RF tone, at a first RF power and a first RF frequency, to modulate at least one laser beam into a first modulated laser beam via an acousto-optic device. For example, the RF controller 430, the RF controller 530, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for applying a first RF tone, at a first RF power and a first RF frequency, to modulate at least one laser beam into a first modulated laser beam via an acousto-optic device.

At 710, the method 700 may cause the acousto-optic device to provide the first modulated laser beam to at least one target ion of an ion chain in the QIP system. For example, the AOM 410, the AOD 504, the light source 502, the optical and trap controller 220 and/or one or more subcomponents of the QIP system 200 or the computer device 300 may be configured to, and/or provide means for causing the acousto-optic device to provide the first modulated laser beam to at least one target ion of an ion chain in the QIP system.

At 715, the method 700 may apply a second RF tone, at a second RF power and at a second RF frequency different than the first RF frequency, to modulate the at least one laser beam into a second modulated laser beam via the acousto-optic device. For example, the RF controller 430, the RF controller 530, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for applying a second RF tone, at a second RF power different than the first RF power and at a second RF frequency different than the first RF frequency, to modulate the at least one laser beam into a second modulated laser beam via the acousto-optic device. The application of the second RF tone allows the RF driver to maintain a constant output RF power by using the second RF tone to complement the first RF tone. As the first RF tone increases, the second RF tone may decrease and vice versa. Consequently, the overall output RF power may be constant, and the RF driver may reduce the transient effects.

At 720, the method 700 may cause the acousto-optic device to provide the second modulated laser beam to one or more ions in the ion chain, wherein the second modulated laser beam does not change any quantum state of the one or more ions. For example, the AOM 410, the AOD 504, the light source 502, the optical and trap controller 220 and/or one or more subcomponents of the QIP system 200 or the computer device 300 may be configured to, and/or provide means for causing the acousto-optic device to provide the second modulated laser beam to one or more ions in the ion chain, wherein the second modulated laser beam does not change any quantum state of the one or more ions.

Aspects of the present disclosure may include methods and systems for applying a first RF tone, at a first RF power and a first RF frequency, to modulate at least one laser beam into a first modulated laser beam via an acousto-optic device, providing the first modulated laser beam to at least one target ion of an ion chain in the QIP system, applying a second RF tone, at a second RF power different than the first RF power and at a second RF frequency different than the first RF frequency, to modulate the at least one laser beam into a second modulated laser beam via the acousto-optic device, and providing the second modulated laser beam to one or more ions in the ion chain, wherein the second modulated laser beam does not change any quantum state of the one or more ions.

Aspects of the present disclosure include the method and/or system above, wherein the second RF frequency is an idling frequency that is off-resonant from a gate operation associated with the one or more ions.

Aspects of the present disclosure include any of the methods and/or systems above, further comprises increasing the first RF power to a third RF power to generate a third RF tone, applying the third RF tone, at the first RF frequency, to modulate the at least one laser beam into a third modulated laser beam via the acousto-optic device, and providing the third modulated laser beam to the at least one target ion of the ion chain.

Aspects of the present disclosure include any of the methods and/or systems above, further comprises in response to increasing the first RF power to the third RF power, decreasing the second RF power to a fourth RF power, applying the fourth RF power, at the second RF frequency, to modulate the at least one laser beam into a fourth modulated laser beam via the acousto-optic device, and providing the fourth modulated laser beam to one or more ions in the ion chain, wherein the fourth modulated laser beam does not change any quantum state of the one or more ions.

Aspects of the present disclosure include any of the methods and/or systems above, wherein a first sum of the first RF power and the second RF power equals to a second sum of the third RF power and the fourth RF power.

Aspects of the present disclosure include any of the methods and/or systems above, wherein the first sum or the second sum separately equals to a maximum RF power of an RF driver.

Aspects of the present disclosure include any of the methods and/or systems above, wherein the first RF power equals to the second RF power, applying the second RF tone further comprises refraining from applying the first RF tone when applying the second RF tone and applying the first RF tone further comprises refraining from applying the second RF tone when applying the first RF tone.

Aspects of the present disclosure include any of the methods and/or systems above, wherein the first RF power or the second RF power separately equals to a maximum RF power of an RF driver.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of reducing radio frequency (RF) amplifier power transients in a quantum information processing (QIP) system, comprising:
applying a first RF tone, at a first RF power and a first RF frequency, to modulate at least one laser beam into a first modulated laser beam via an acousto-optic device;
causing the acousto-optic device to provide the first modulated laser beam to at least one target ion of an ion chain in the QIP system;
applying a second RF tone, at a second RF power and at a second RF frequency different than the first RF frequency, to modulate the at least one laser beam into a second modulated laser beam via the acousto-optic device; and
causing the acousto-optic device to provide the second modulated laser beam to one or more ions in the ion chain, wherein the second modulated laser beam does not change any quantum state of the one or more ions.

2. The method of claim 1, wherein the second RF frequency is a idling frequency that is off-resonant from a gate operation associated with the one or more ions.

3. The method of claim 1, further comprising:
increasing the first RF power to a third RF power to generate a third RF tone;
applying the third RF tone, at the first RF frequency, to modulate the at least one laser beam into a third modulated laser beam via the acousto-optic device; and
providing the third modulated laser beam to the at least one target ion of the ion chain.

4. The method of claim 3, further comprising:
in response to increasing the first RF power to the third RF power, decreasing the second RF power to a fourth RF power;
applying the fourth RF power, at the second RF frequency, to modulate the at least one laser beam into a fourth modulated laser beam via the acousto-optic device; and
providing the fourth modulated laser beam to one or more ions in the ion chain, wherein the fourth modulated laser beam does not change any quantum state of the one or more ions.

5. The method of claim 4, wherein a first sum of the first RF power and the second RF power equals to a second sum of the third RF power and the fourth RF power.

6. The method of claim 5, wherein the first sum or the second sum separately equals to a total RF power of a RF driver.

7. The method of claim 1, wherein:
the first RF power equals to the second RF power;
applying the second RF tone further comprises refraining from applying the first RF tone when applying the second RF tone; and
applying the first RF tone further comprises refraining from applying the second RF tone when applying the first RF tone.

8. The method of claim 7, wherein the first RF power or the second RF power separately equals to a maximum RF power of a RF driver.

9. An acousto-optic system in a quantum information processing (QIP) system, comprising:
a radio frequency (RF) driver configured to:
apply a first RF tone, at a first RF power and a first RF frequency, to modulate at least one laser beam into a first modulated laser beam via an acousto-optic device, and
applying a second RF tone, at a second RF power and at a second RF frequency different than the first RF frequency, to modulate the at least one laser beam into a second modulated laser beam via the acousto-optic device; and
the acousto-optic device configured to:
provide the first modulated laser beam to at least one target ion of an ion chain in the QIP system, and
provide the second modulated laser beam to one or more ions in the ion chain, wherein the second modulated laser beam does not change any quantum state of the one or more ions.

10. The acousto-optic system of claim 9, wherein the second RF frequency is an idling frequency that is off-resonant from a gate operation associated with the one or more ions.

11. The acousto-optic system of claim 9, wherein:
the RF driver is further configured to:
increase the first RF power to a third RF power to generate a third RF tone, and
apply the third RF tone, at the first RF frequency, to modulate the at least one laser beam into a third modulated laser beam via the acousto-optic device; and
the acousto-optic device is further configured to provide the third modulated laser beam to the at least one target ion of the ion chain.

12. The acousto-optic system of claim 11, wherein:
the RF driver is further configured to:
in response to increasing the first RF power to the third RF power, decrease the second RF power to a fourth RF power, and
apply the fourth RF power, at the second RF frequency, to modulate the at least one laser beam into a fourth modulated laser beam via the acousto-optic device; and
the acousto-optic device is further configured to provide the fourth modulated laser beam to one or more ions in the ion chain, wherein the fourth modulated laser beam does not change any quantum state of the one or more ions.

13. The acousto-optic system of claim 12, wherein a first sum of the first RF power and the second RF power equals to a second sum of the third RF power and the fourth RF power.

14. The acousto-optic system of claim 13, wherein the first sum or the second sum separately equals to a maximum RF power of a RF driver.

15. The acousto-optic system of claim 9, wherein:
the first RF power equals to the second RF power;
the RF driver is further configured to:
refrain from applying the first RF tone when applying the second RF tone; and
refrain from applying the second RF tone when applying the first RF tone.

16. The acousto-optic system of claim 15, wherein the first RF power or the second RF power separately equals to a total RF power of a RF driver.

17. A non-transitory computer readable medium comprising instructions that, when executed by a processor of a quantum information processing (QIP) system, cause the processor to:
cause a radio frequency (RF) driver to apply a first RF tone, at a first RF power and a first RF frequency, to modulate at least one laser beam into a first modulated laser beam via an acousto-optic device;
cause the acousto-optic device to provide the first modulated laser beam to at least one target ion of an ion chain in the QIP system;
cause a RF driver to apply a second RF tone, at a second RF power and at a second RF frequency different than the first RF frequency, to modulate the at least one laser beam into a second modulated laser beam via the acousto-optic device; and
cause the acousto-optic device to provide the second modulated laser beam to one or more ions in the ion chain, wherein the second modulated laser beam does not change any quantum state of the one or more ions.

18. The non-transitory computer readable medium of claim 17, further comprising instructions for:
causing the RF driver to increase the first RF power to a third RF power to generate a third RF tone;
causing the RF driver to apply the third RF tone, at the first RF frequency, to modulate the at least one laser beam into a third modulated laser beam via the acousto-optic device; and
causing the RF driver to provide the acousto-optic device to provide the third modulated laser beam to the at least one target ion of the ion chain.

19. The non-transitory computer readable medium of claim 18, further comprising instructions for:
in response to increasing the first RF power to the third RF power, causing the RF driver to decrease the second RF power to a fourth RF power;
causing the RF driver to apply the fourth RF power, at the second RF frequency, to modulate the at least one laser beam into a fourth modulated laser beam via the acousto-optic device; and
causing the RF driver to provide the fourth modulated laser beam to one or more ions in the ion chain, wherein the fourth modulated laser beam does not change any quantum state of the one or more ions.

20. The non-transitory computer readable medium of claim 19, wherein a first sum of the first RF power and the second RF power equals to a second sum of the third RF power and the fourth RF power.
